(19) United States
(12) Patent Application Publication
(10) Pub. No.: US 2002/0044633 A1
(43) Pub. Date: Apr. 18, 2002

(54) Method and system for speech-based publishing employing a telecommunications network

(75) Inventors: Ranjeet Nabha, New York, NY (US); Christos A. Polyzois, Chatham, NJ (US); Nikolaos Anerousis, New York, NY (US); Euthimios Panagos, Madison, NJ (US)

Correspondence Address: Mitchell A. Stein, Esq., STEIN & ASSOCIATES, P.C., 489 Fifth Avenue, 29th Floor, New York, NY, 10017, US

(73) Assignee: VoiceMate. com, Inc.

(21) Appl. No.: 09/832,640

(22) Filed: Apr. 11, 2001

Related U.S. Application Data
(63) Continuation-in-part of application No. 09/295,967, filed on Apr. 21, 1999.

(51) Int. Cl. H04M 11/00

(52) U.S. Cl. 379/90.01

(57) ABSTRACT

A method and system for authoring digitized information pieces, involving a telephone device for access to a global telecommunications system, and for providing commands and for retrieval and authoring of Internet-based content and an Internet-based platform for transmission of information to and from the telephone device via the global telecommunications systems and for receiving commands and for managing authored digitized information pieces. The platform has the following components: a telephony server for interfacing with the telephone device, a server for providing instructions to the telephony server, a web server for receiving and transmitting content from the Internet, a media server for managing media information flow and storage, a storage device for receiving instructions from the media server and for storing and retrieving information in accordance with the instructions, a database server for managing metainformation data flow among the platform-accessed components, a general application server for hosting software necessary for the implementation of additional functionality, and software for providing authoring functions integrated to the components of the platform.

### REFERENCE TO RELATED APPLICATIONS

This application is a continuation-in-part of U.S. Ser. No. 09/295,967, filed Apr. 21, 1999, the contents of which are incorporated by reference in their entirety.

### FIELD OF THE INVENTION

The present invention relates to the field of publishing information via a telecommunications network, and more particularly to speech-enabled publishing of information via a telephone device.

### BACKGROUND OF THE INVENTION

Recent advances in speech recognition technology have transformed the telephone from a simple communication medium to an information retrieval system. Since the number of people with access to a telephone is estimated to exceed 4.5 billion worldwide by 2004 and, furthermore, communications and information are becoming digital, people will soon expect to have access to information and create and disseminate information whenever they want, and wherever they are, by employing the most natural and trusted medium—the human voice, through the most natural and trusted vehicle—the telephone.

However, current speech-enabled applications delivered to and from a telephone, are limited to simple transaction-based services (e.g., banking, trading and travel booking) and access to pre-canned information (e.g., driving directions, stock quotes, restaurant reviews and news). In other words, a person may access information via his or her telephone, but such access is typically limited to DTMF-tone dependent transactional services, or the delivery of pre-recorded (or text-to speech enhanced) information that is classified in certain ways, from which the person is permitted a DTMF-tone dependent selection, the content of which is then played through the telephone handset. In certain of such situations, the technology has advanced, but only to the point of providing speech-recognition systems for enabling the selection.

Furthermore, existing speech-based authoring applications are typically limited solely to voice-mail and voice-mail enhancements, and are therefore built around a very rigid structure with rudimentary functionality. Such applications permit the user to record and retrieve pre-recorded messages via a telephone handset and to forward such messages, but offer no greater functionality than such limited uses. For example, configuring voice-mail applications through “provisioning” is shown in U.S. Pat. No. 6,031,904 to An, et al.

Typically, voice messaging refers to a computer-based asynchronous communication technology, where a computer manages the receipt, sending, interception, storage and subsequent retrieval of audio messages, but the messages are not heard by the intended recipient until after the computer-management phase is complete. Voice messaging systems thereby permit users to use their telephone to record voice messages and send them to either a specific individual or a group of individuals that are part of the same distribution list, with notification to the recipient that the message is available for retrieval.

Some existing voice messaging systems, like the Intuity AUDIX messaging system from Lucent Technologies, offer a very sophisticated array of features. However, such systems do not support advanced speech-based content authoring applications. For example, such systems permit the user to create an audio message, and to send that message to a recipient or group of recipients. Each recipient is then given the ability to listen (or skip, forward or delete) messages in the temporal (i.e., time-based) order in which they were received. Such systems do not generally provide any other form of authoring.

Accordingly, such existing voice messaging systems are incapable of, for example, permitting the user to create a multiplicity of different audio pieces under subject headings or in any other mechanism of ordering other than temporal, because such applications would require, at a minimum, either the authoring of multiple related audio pieces or the ability to segment a long audio piece, concurrently while it is being recorded and accessed, into multiple parts and explicitly editing and updating such parts at a later time. Moreover, such systems have no capacity to deal with non-audio related information, including, for example, text-based information.

Interactive voice response (IVR) systems, known in the art, connect telephone users with information stored in computer databases. Since such systems are not live, but rather automated; they provide the user with the ability to access information stored in a database at any time, and from wherever a device (typically telephony-based) is located. Conventional IVR systems use dual-tone multi-frequency (“DTMF”) signaling to allow a user to interact with the system via a standard telephone keypad. Recently, IVR systems have provided the ability to integrate speech recognition into their environment in order to support transactional services (e.g., stock trading, travel booking, banking and directory assistance) that would have been very tedious or impractical to carry out using solely a DTMF interface. Such systems also provide support for recording responses to specific queries, and the forwarding of those responses to a recipient or group of recipients (as in, e.g., a query stating “please leave your question after the tone” followed by a recording period). Although current state of the art IVR systems offer speech-based publishing capabilities as specifically stated above, such capabilities fall within the category of simple message recording, functionally identical to the capabilities provided by voice messaging services.

Webcasting or Internet broadcasting is known in the art to be the transmission of live or pre-recorded audio or video to computers that are connected to the Internet. The software that enables webcasting is known as streaming media, based upon protocols including, e.g., “rtsp” which was established in 1998. Typically, streaming media technologies transmit audio and video from a centralized database to an application running on a computer that has queried the database. Such technologies include, by way of example, applications called “media player” or “real audio.” Accordingly, in order for such applications to function, a computer must be connected to the Internet, have a sound card, speakers, and a running application (like media player). The computer, while running the application, then queries through the Internet in accordance with a URL, receives the stream, buffers and plays the content. Such applications include, by way of example, Yahoo's broadcasting engine, found at www.broadcast.com. Such broadcasting engines, while offering a personal computer-based environment for receipt of streams and for the creation and transmission of such streams (including text messaging), nonetheless fail to address speech-based authoring by way of a telephone. (By way of background, “WAP” phones are also known in the art. However, such “web-enabled” telephony merely uses the telephone keypad as a gateway to the Internet, and thus do not provide any form of speech-based authoring.)

Today, there are several efforts to record an audio file and associate it as a link with a pre-existing web page. For example, BYOBroadcast (www.byobroadcast.com) offers a voice application, referred to as “Audio Posting System,” which provides subscribers with the ability to post on their web site, by using the telephone, personalized audio messages in their own voice. Thus, functionally, this system is no better than recording an outgoing message on a voice messaging system. In addition, a multimedia PC is the only mechanism for uploading a previously recorded audio file, updating messages and reviewing existing messages before they are made available to visitors of the WEB site. In such applications, the telephone is not both the device for the creation and retrieval of speech-authored material. Rather, it is a one-way device for merely creating an audio file which is linked to pre-existing material by a processing stage that is run without the use of the telephone.

Voice portals provide telephone users with a speech-recognition based interface to access and retrieve WEB content over an office, wireless or home telephone. Currently, there are several companies offering voice portal services nationwide, including, by way of example, Tellme (http://www.tellme.com), BeVocal (http://www.bevocal.com) and HeyAnita (http://www.heyanita.com). These portals generally offer a similar, limited range of simple content: news, sports scores, stock quotes, traffic reports, weather, and horoscopes. Speech recognition software is used to understand the callers' requests and then respond with pre-recorded audio pieces, text-to-speech, or concatenated speech (i.e., concatenation of pre-recorded words into sentences). While some of the existing voice portals allow the authoring of audio pieces over the telephone, such authoring capabilities are limited to a single audio piece with no ability to support audio broadcasting or segmentation, or association of multiple audio and other files together.

Observably, there have been recent fundamental and rapid changes in speech-enabled applications and user expectations. Speech recognition and text-to-speech (“TTS”) technologies have experienced dramatic advances, powered by huge increases in processing power, increasing densities and decreasing costs of voice processing and network interface hardware. At the same time, the adoption of standard voice markup languages, like the voice extensible markup language (“VXML”), is expected to fuel speech-enabled applications in the same way the hypertext markup language (“HTML”) fueled Internet applications.

On the other hand, the Internet has raised user expectations, and people expect to access and manage information dynamically and rapidly. As people grow more accustomed to the plethora of information and services available in the Internet (e.g., news, weather, stock quotes, collaborative computing, publishing and document management) we can expect the need to transit from the personal computer interface to the natural speech interface provided through use of a telephone handset. The instant invention is directed toward satisfying that expected need, which heretofore remains unsatisfied in the art.

Accordingly, it is an object of the current invention to provide a telephone as a complete, stand alone interface to speech-based authoring tools for the creation, segmentation, association and tagging of audio and other files, and for speech-based dissemination of such information.

It is another object of the current invention to provide segmentation of an audio stream to permit users to log their speech-based notes concurrently with the receipt of live and other audio broadcasts through the telephone handset as a stand-alone device.

It is still a further object of the current invention to provide a user-specified dynamic or template driven linking system for such audio content.

It is yet a still further object of the current invention to provide multiple users with the ability to concurrently record speech-based pieces, which are assembled into a single audio stream that is broadcast virtually simultaneously with the recorded pieces, accessible via the Internet and global telecommunications networks.

It is still yet a further object of the current invention to provide simultaneous access to, and modification of Internet-based information by way of a telephone device and a computer device (including, e.g., WAP phones, PDA's, etc.) that concurrently and cooperatively operate through the same platform.

### SUMMARY OF THE INVENTION

The various features of novelty which characterize the invention are pointed out with particularity in the claims annexed to and forming a part of the disclosure. For a better understanding of the invention, its operating advantages, and specific objects attained by its use, reference should be had to the drawings and descriptive matter in which there are illustrated and described preferred embodiments of the invention.

The foregoing objects and other objects of the invention are achieved through a method and system for authoring digitized information pieces, involving a telephone device for access to a global telecommunications system, and for providing commands and for retrieval and authoring of Internet-based content and an Internet-based platform for transmission of information to and from the telephone device via the global telecommunications systems and for receiving commands and for managing authored digitized information pieces.

The platform has the following components: a telephony server for interfacing with the telephone device, a server for providing instructions to the telephony server, a web server for receiving and transmitting content from the Internet, a media server for managing media information flow and storage, a storage device for receiving instructions from the media server and for storing and retrieving information in accordance with the instructions, a database server for managing metainformation data flow among the platform-accessed components, a general application server for hosting software necessary for the implementation of additional functionality, and software for providing authoring functions integrated to the components of the platform.

Accordingly, it is a feature of the present invention to provide authoring technology to Internet-based information through a telephone device alone, or with any Internet connecting device, or by way of a combination thereof.

Other features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims.

### BRIEF DESCRIPTION OF THE DRAWINGS

In the drawings, wherein similar reference characters denote similar elements through the several views:

FIG. 1 is an overall, diagrammatical system summary of the preferred embodiment of the instant invention;

FIG. 2 is a diagrammatical representation of a system flow showing application selection and authoring selection, in accordance with the preferred embodiment of the subject invention;

FIG. 3 is a diagrammatical representation of a system flow showing the steps involved in authoring content, in accordance with the subject invention;

FIG. 4 is a diagrammatical representation of a system flow showing the steps involved in a real-time broadcast, in accordance with the subject invention;

FIG. 5 is a diagrammatical representation of a system flow showing the steps involved in editing and updating a piece, in accordance with the subject invention; and

FIG. 6 is a diagrammatical representation of a system flow showing a specific embodiment of application-specific authoring generally shown in FIG. 2, and directed to a conference call.

### DETAILED DESCRIPTION OF THE PREFERRED EMBODIMENTS

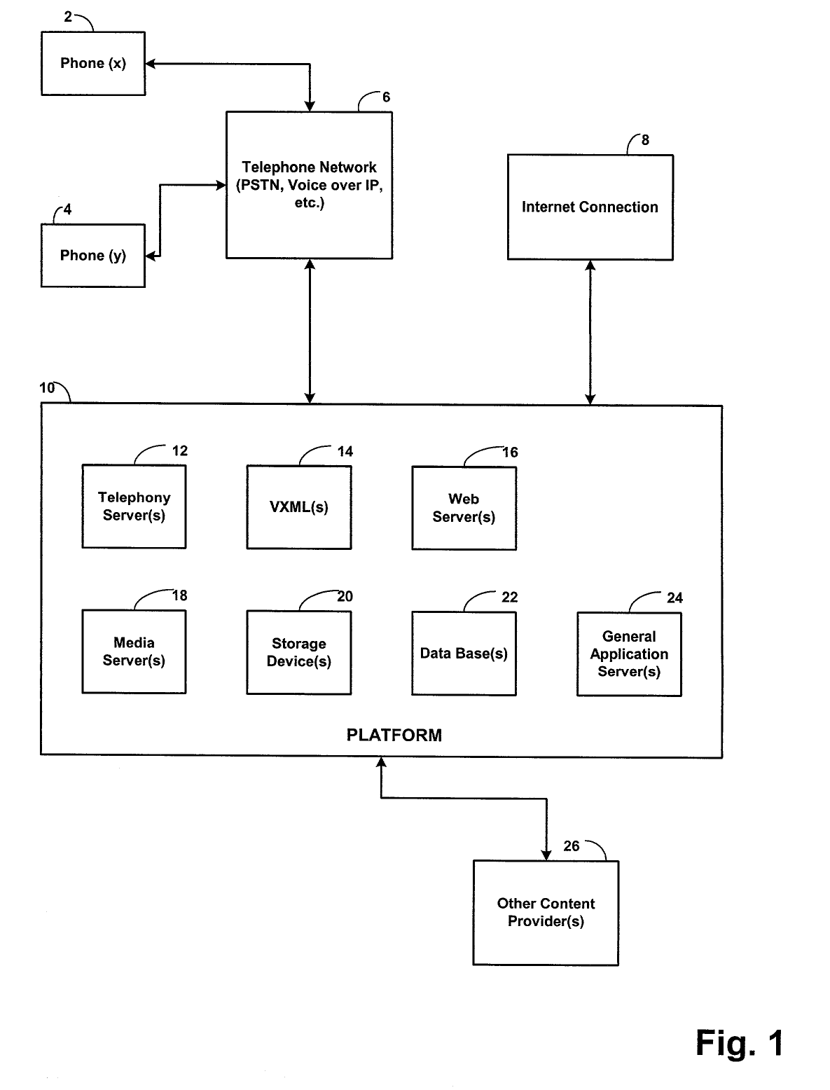

In accordance with the subject invention, and with particular reference to FIG. 1, landline telephone 2 (analog or digital) and wireless telephone 4 (analog or digital) are employed to call a telephone number specific to telephone network 6, and thereby engage platform 10. Similarly, platform 10 can be engaged by an Internet connection 8 formed by any computer or other portable device with the Internet. Platform 10 contains software and hardware that enable the instant invention. The preferred embodiment for connectivity is via a general telecommunications network 6 that is not provider-specific.

In particular, platform 10 maintains telephony servers 12, VXML interpreters and servers 14, WEB servers 16, media servers 18, storage devices 20, databases 22, and general application servers 24. In addition, platform 10 connects with external content providers 26 and accesses information stored with such providers.

Telephony servers 12 comprise computers that have one or more telephony boards attached to them (analog, T-1, E-1) and run continuous speech processing (“CSP”) software. VXML interpreters and servers 14 offer access to the speech-enabled services of the instant invention using voice interfaces. In particular, VXML interpreters and servers 14 handle synthesized speech for text-to-speech recognition of spoken input, recognition of DTMF, playout of audio, recording of spoken input, and telephony call control.

WEB servers 16 provide access to platform 10 via Internet connection 8. Media servers 18 employ storage devices 20 to manage the physical aspects (e.g., storage) of information and services provided by platform 10. Databases 22 provide storage and retrieval of metadata associated with the information and services provided by platform 10, and, in addition, store and manage customer and user related information, such as personal profiles and usage records. Finally, general application servers 24 provide specialized services, such as encoding and streaming of audio content (e.g., a RealAudio server from Real Networks).

It should be appreciated that in the preferred embodiment, information is primarily broadcast by, and instructions received from a telephone device. The customer or user of the instant invention enters verbal commands into the telephone, in the same manner as ordinary telephone usage, and DTMF tones via the keypad. The information is streamed by platform 10 through network 6 to be broadcast to that customer or user at phone (x) and (y), items 2 and 4, in FIG. 1. It should also be appreciated that, in a preferred embodiment, the telephone device engages platform 10 simultaneously and concurrently with Internet connection 8 which may include, by way of example, a personal computer, portable laptop or notebook, PDA, or WAP-enabled device. Under this embodiment, the user can speak commands into the telephone device while simultaneously entering information (or for that matter receiving information) via Internet connection 8, all controlled and integrated through platform 10, or alternatively enter and retrieve information directly through Internet connection 8 without use of the telephone device, or may engage the telephone device subsequent to entry via Internet connection 8. However, it is the preferred embodiment to provide access, authoring and retrieval primarily, if not exclusively, via the telephone device.

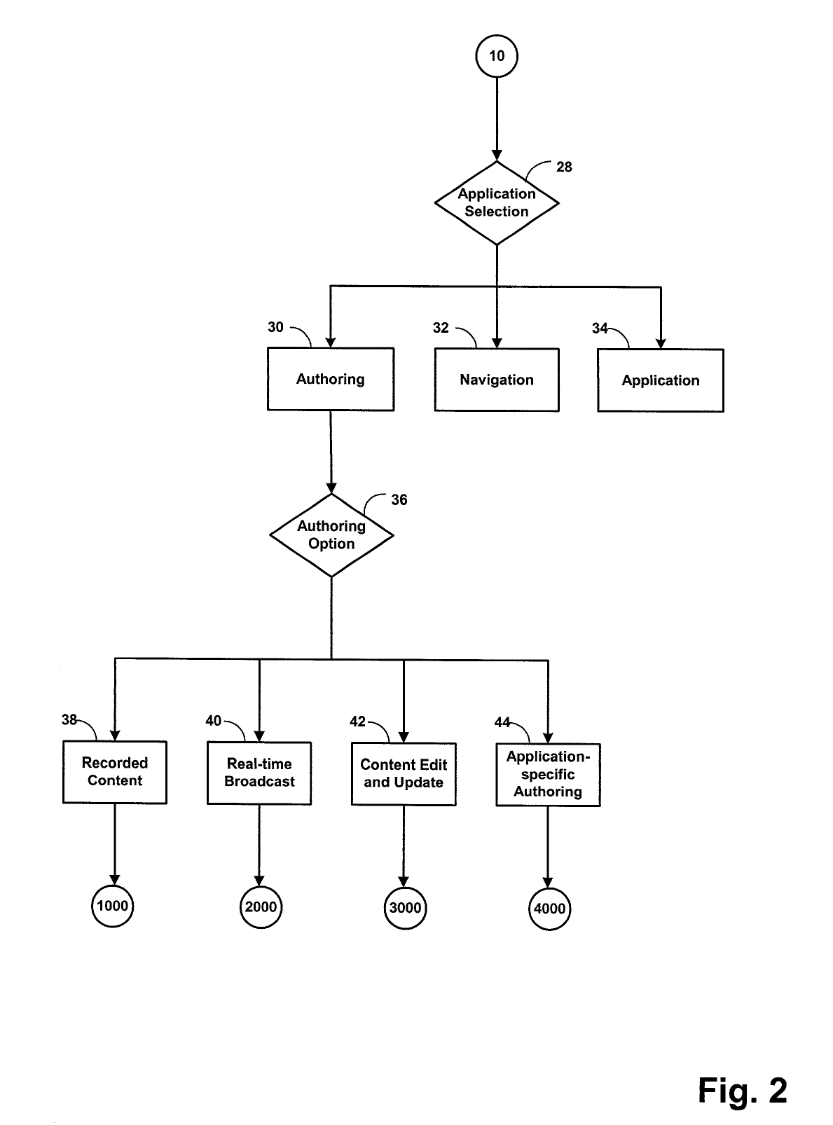

In the preferred embodiment, a customer or user of the instant invention is provided with a telephone number to access platform 10, and simply calls that number from any telephone, at any time. Upon calling that number, the call is routed to a telephony server 12 (which contains relevant portions of the inventive proprietary method and system), and as shown in FIG. 2, upon such call, a number of steps are implemented to allow access to authoring tools provided in accordance with a preferred embodiment of the instant invention. In an alternative embodiment, a customer or user of the instant invention is given a Uniform Resource Locator (“URL”) reference to access platform 10, and uses any WEB browser to access platform 10 and engage one or more of its services and applications, at any time.

In either event, first step 28 of FIG. 2 allows the user to select among several applications. In the preferred embodiment, the outcome of selection step 28 is authoring step 30, navigation step 32, or application step 34. In this regard, the steps involved in determining initialization information, creating and accessing customer and user profiles, and allowing access to platform 10 are stated in the co-owned “Method and System for the Provision of Internet-based Information in Audible Form” International Application PCT/US00/10717, the contents of which are incorporated herein by reference.

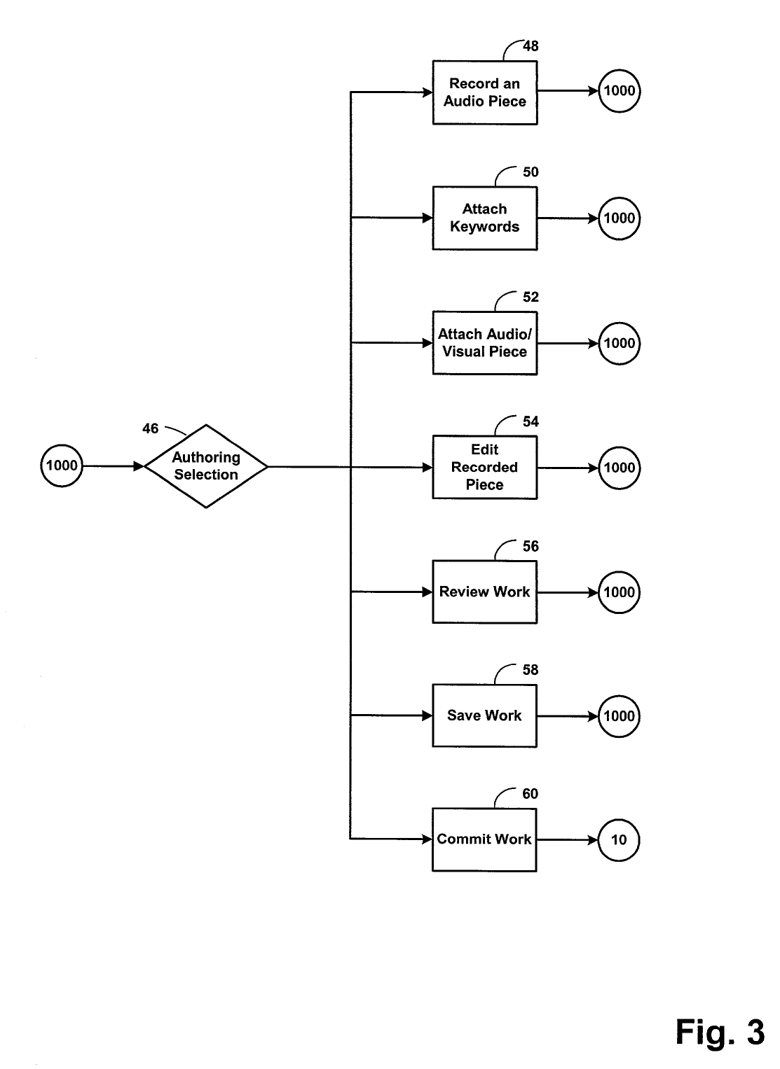

Authoring option step 36 of FIG. 2 provides a user who has selected step 30, with the ability to choose among several authoring steps. Recorded content step 38, which is explained in greater detail with reference to FIG. 3, below, provides users with the ability to create content that includes their own recorded audio content, existing recorded audio content, existing visual content, and references to audio and visual content stored with external content providers (via item 26, as shown in FIG. 1).

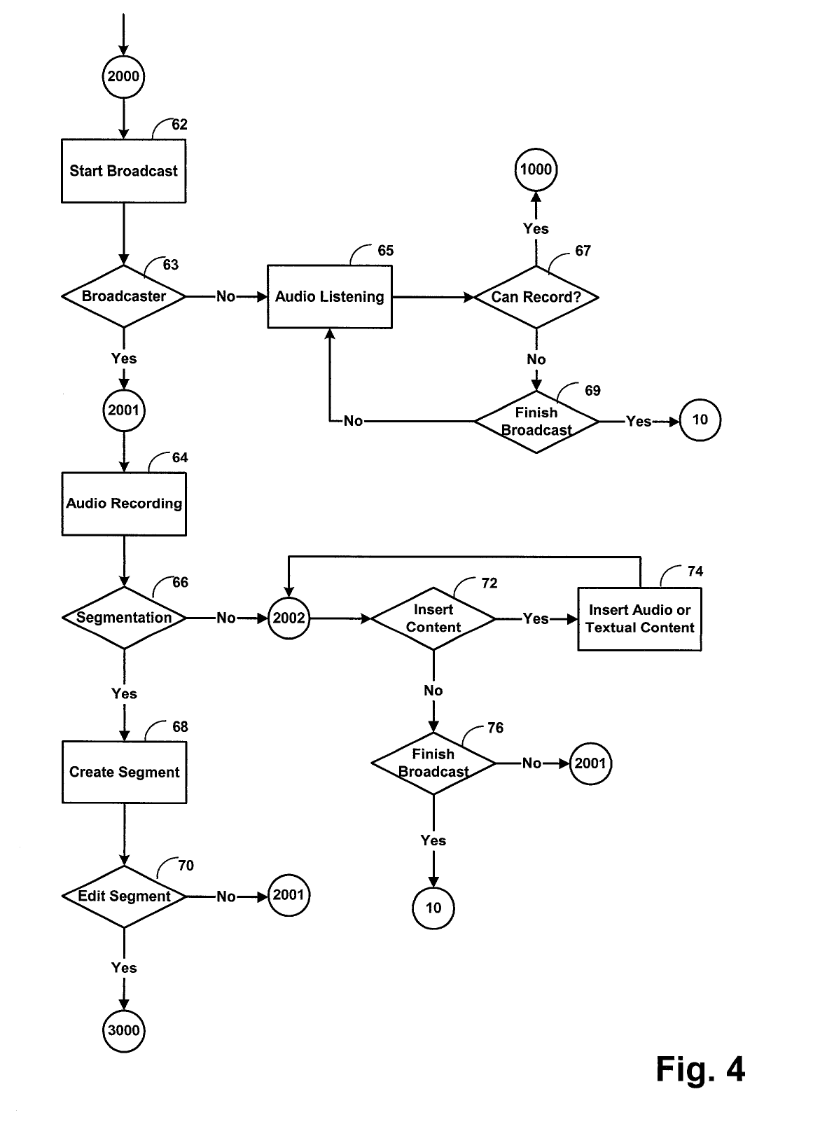

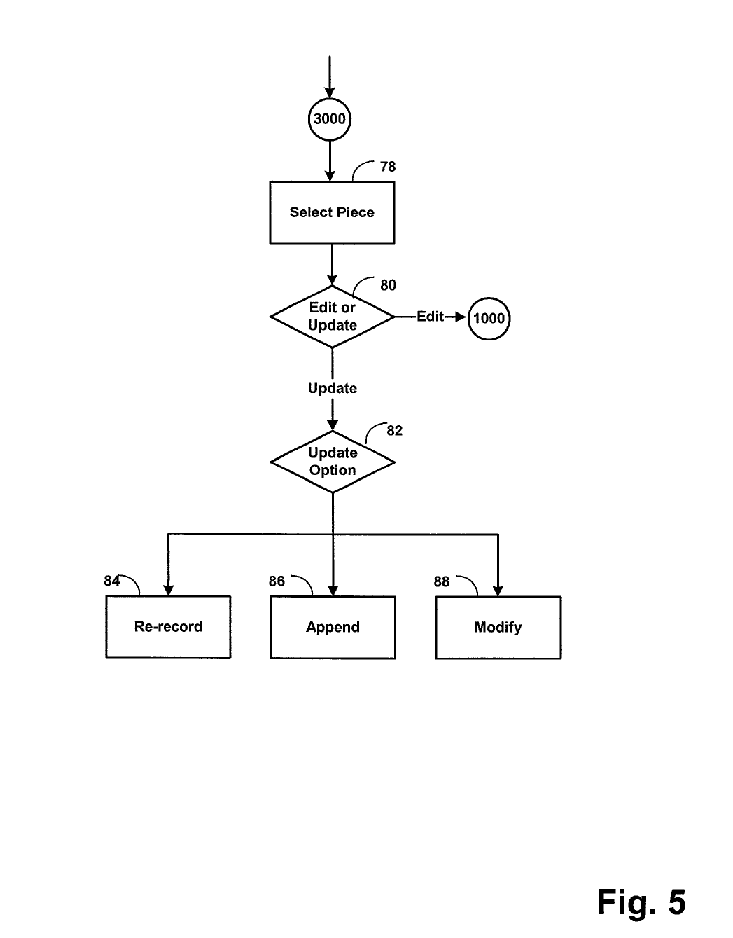

Real-time broadcast step 40, which is explained in greater detail with reference to FIG. 4, below, permits users to initiate a real-time broadcast of audio content. Pursuant to the user's election, the broadcasted audio is split into several segments, which are then edited and updated at a later time, in accordance with the procedures set forth in FIG. 5, below. Furthermore, existing audio and textual content is inserted into the broadcast, substantially simultaneously with the broadcast, at the user's and/or broadcaster(s)' request.

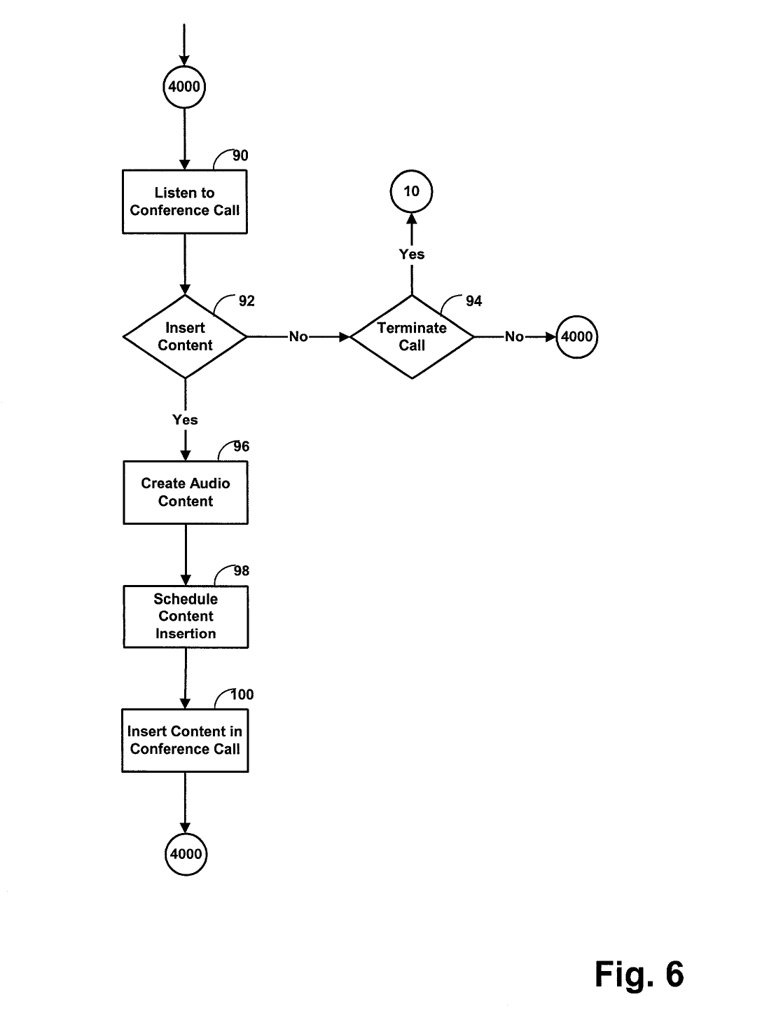

Content edit and update step 42, which is explained in greater detail with reference to FIG. 5, below, provides users with the ability to edit existing content, both audio and textual, create new content, and associate such content with pre-existing content. Finally, application-specific authoring step 44, which is explained in greater detail with reference to FIG. 6, below, provides users with the ability to interact with specialized authoring applications, including those described in connection with FIG. 6, below.

FIG. 3 illustrates the steps involved in the recorded content authoring step 38 of FIG. 2, in accordance with a preferred embodiment of the invention. In particular, step 46 provides the user with the ability to select among several authoring options. While the options are required under the subject invention, the specific sequence is not, nor are such options exclusive of the addition of other authoring applications. In the preferred embodiment, the user interacts with the authoring application shown in FIG. 3 by either entering verbal commands into the telephone, pressing the keys in the telephone's keypad, or using any combination of the two. In an alternative embodiment, the user interacts with the authoring applications shown in FIG. 3 via a computer device with, or in the absence of a telephone device.

The subject invention supports arbitrary authoring applications of audio content. More specifically, authoring options are pre-programmed and made available for each alternative embodiment of the present invention. One of ordinary skill in the art will appreciate that the execution of the authoring options need not be sequential, simultaneous, or executed by the same device. Moreover, some options can be omitted or re-executed immediately after execution, without the need to execute any other of the options therebetween. The group, however, is critical and fundamental to the subject invention in order to achieve authoring functionality.

In step 48 of FIG. 3, the user records an individual audio piece and then returns to step 46 to choose another authoring option. At step 50, the user is provided with the ability to attach one or more keywords to the audio piece recorded in step 48. In this embodiment, keywords are selected from a pre-defined set or are specific to each user. Keywords are used to facilitate search operations that attempt to locate content relevant to user criteria. In this manner, when a keyword is attached to an audio piece, keyword searching tools are enabled to search for such keywords, thereby locating the tagged audio piece, and providing for its retrieval and broadcast. Attachment, in accordance with the subject invention, provides for detachment or other editing or modification subsequent to the attachment stage.

In step 52, the user is given the option of selecting to associate one or more existing pieces of audio or visual information with the audio recording(s) created under step 48. A keyword-based search can be used for selecting such content, or content navigation can be employed, or references to content stored with the external content providers 26 of FIG. 1 can be used in step 52.

In step 54, the user is given the option of editing an audio recording made via step 48. Editing of audio recordings provides the options of re-recording, deletion, and appending to the existing recording. Editing also permits deletion of a specific portion of the audio recording or insertion of additional audio content at a specific offset of the audio recording. Such tools are rendered available over the telephone handset to the user and are subject to the user's selection and employment.

In step 56, the user is given the option of reviewing the work resulting from steps 48, 50, 52, and 54. Thereafter, the user can repeat any of these steps until the desired outcome is reached. Step 58 permits the user to save the work done prior thereto, thereby enabling the user to return and complete the work at a later time. Finally, step 60 provides the user with the option of committing to the recorded content and returning either to step 38 (for recording new content) or to step 28 (for selection among authoring step 30, navigation step 32 and application step 34), as shown in FIG. 2.

When the user elects to engage commit step 60, platform 10 of FIG. 1 updates the database(s) and storage devices 20 to reflect the existence of new content and triggers any workflow processes that may be associated with the newly published content. An example of such a workflow process includes, e.g., compliance review, required in the financial industry for content pieces that are made available to the public or a selected group of people. In addition, depending upon the content, and after commit step 60 is selected by the user, platform 10 of FIG. 1 may instruct an application server 24 as shown in FIG. 1 to commence encoding the newly recorded audio pieces using different encoding formats (e.g., real audio, windows media, mp3, etc.). It should be appreciated that the commitment stage 60 can be automatically engaged in, for example, a failure to respond to a query within a certain period of time, or otherwise, thereby permitting the workflow process to automatically commence without the necessity of the user's actual decision to commit. It should also be appreciated that the encoding of the recorded audio pieces using different encoding formats can also commence prior to the commitment stage 60, anticipating the subsequent commencement of the commitment stage 60.

The user is also given the ability to cancel the recorded content selection step 46 of FIG. 3 at any time, via a number of ways. For example, the user can explicitly instruct the system to cancel by employing a specific word, phrase, or DTMF tone(s).

The following example demonstrates the recording of several audio pieces according to the preferred embodiment of the subject invention. Those skilled in the art should realize that the following example is provided for illustrative purposes only, and it does not limit the scope of the current invention. In this example, “System” refers to platform 10 of FIG. 1 and “Caller” refers to a user using a telephone to interact with the platform.

System: To publish say, “Publish” at any time

Caller: Publish

System: Your story will contain three separate pieces, the headline, the body, and the keywords

System: To record the headline, say “Headline” or press 1

System: To record the body, say “Body” or press 2

System: To record the keywords to the story, say “Keywords” or press 3

Caller: Headline

System: You are publishing the story headline

System: You can operate your phone as a voice recorder. To begin recording, press 8. To stop recording, press 5. To return to the previous menu and record another piece, press #

Caller: (Pressing keypad number 8 to emit DTMF tone 8)

Caller: This is the story headline . . .

Caller: (Pressing keypad number 5 to emit DTMF tone 5)

Caller: (Pressing keypad # to emit DTMF tone #)

Caller: Body

Caller: (Pressing keypad number 8 to emit DTMF tone 8)

Caller: This is the story body.

Caller: (Pressing keypad number 5 to emit DTMF tone 5)

Caller: (Pressing keypad # to emit DTMF tone #)

In the foregoing example, it should be understood that the actual communication continues, but utilizes the same general techniques thereby exemplified.

FIG. 4 shows the elements of the process by which a real-time audio broadcast is carried out using relevant portions of the current invention. While a standard telephone, analog or digital, is connected to platform 10 of FIG. 1 using a standard telephone line, it should be appreciated that the system applies to a cellular or other telephony device equally, and without limitation, and to a single or multiple users cooperatively utilizing the system by way of a multiplicity of such telephony devices. The user interacts with platform 10 by using either verbal commands together with or independent of the telephone's keypad to initiate a real-time audio broadcast via step 62.

In accordance with a preferred embodiment shown in FIG. 4, after the real-time audio broadcast is initiated, essentially two categories of users participate in the broadcast: the broadcaster(s) and the listener(s). Step 63 determines the category in which the user belongs, based upon the credentials provided by the user upon engaging platform 10 of FIG. 1.

After the real-time broadcast is initiated, a broadcaster simply speaks on the telephone, in normal human speech, via step 64. During this step, platform 10 gathers the broadcaster's input and makes such input substantially immediately available for transmission through the Internet in digital, streaming form and through a telephone device in audible form by way of allocating a multicast Internet address, updating database 18 and media servers 16, and multicasting the broadcaster's input to telephone servers 12 and general application servers 24.

The order in which broadcasters speak is determined by the moderator(s) of the broadcast, or is otherwise determined among the broadcasters before the commencement of the broadcast, or during the broadcast.

Step 66 gives the broadcaster the option of deciding whether to create an audio segment, thereby creating a sub-portion of the broadcast that can be played, edited and modified subsequently and independently via step 70 which permits access at point 300 back to editing, as described in FIG. 5, or to point 2001 to continue the broadcast. Using either specific verbal commands and/or pre-defined DTMF tones from the telephone keypad, the electing user creates such an audio segment via step 68. This created audio segment automatically (without user input or selection) records all user input from either the commencement of the broadcast or the creation of the most recent segment. This newly created segment can be immediately made available to users accessing platform 10 via a telephone or an Internet connection, or is otherwise made available after termination of the broadcast.

In step 72, the broadcaster is given the option of inserting an audio or textual recording in the broadcast. If the broadcaster elects to insert such a recording, step 74 is employed for selecting the recording and inserting the selected recording into the broadcast by looping back to point 2002, thereby permitting insertion of yet another content piece via the same process. When the broadcaster elects not to insert content at step 72, then the broadcaster can elect to continue and finish the broadcast via step 76 which loops back to point 2001, or to terminate and return via step 10 to platform 10 as shown in FIG. 1.

A keyword-based search can be used for selecting such audio content to be inserted, or content navigation can be employed for that purpose. By way of example, the inserted content could correspond to a recorded audio piece that was made by one of the listeners during step 67, or some other piece that the broadcaster deems relevant to the content of the broadcast. In addition, in the case of a textual recording, TTS is employed for creating an audio representation of the textual document.

When the user is identified as a non-broadcaster via step 63, and listening has commenced via step 65, decision at step 67 permits, when such permission is supplied, the listener to record via authoring step 46, as shown in FIG. 3. When permission is denied to the user to record at step 67, then the user either elects via step 69 to return to audio listening step 65, or to exit and return to platform 10, as shown in FIG. 1.

The following example demonstrates a real-time audio broadcast and segmentation in accordance with the subject invention. In this example, “System” refers to platform 10 of FIG. 1 and “Caller” refers to a user using a telephone to interact with the platform.

System: To broadcast say, “Broadcast” at any time

Caller: Broadcast

System: This is the Voicemate morning call broadcast. You can broadcast your call live and save sections of it as individual stories

System: To begin the broadcasting sequence, say, “begin broadcast”

Caller: Begin Broadcast

System: To begin your broadcast, press #

System: To save the current section as a story, press 9

System: To end transmission, press #

Caller: (Pressing keypad # to emit DTMF tone #)

System: Please begin your broadcast

Caller: This is the first section of the call . . .

Caller: (Pressing keypad number 9 to emit DTMF tone 9)

Caller: (Pressing keypad # to emit DTMF tone #)

Caller: This is the second section of the call

Caller: (Pressing keypad # to emit DTMF tone #)

System: Are you sure you want to end the broadcast?

Caller: Yes

System: The broadcast has ended

In the foregoing example, it should be understood that the actual communication may include other steps, including, e.g., the insertion of existing content, but utilizes the same general techniques thereby exemplified.

FIG. 5 shows the procedures used in connection with content editing and updating by a user of the system. In step 78, the user is provided the option of selecting a specific content piece to update. This content piece is local to platform 10 of FIG. 1 or, alternatively, stored with an external content provider 26, also as shown in FIG. 1. Generally, the content piece to be updated is an audio piece, although textual and other pieces are enabled by the subject invention.

In step 80, as shown in FIG. 5, the user is given the option to select either to edit or update the content piece designated via step 78. In the former case, the user performs any one or more of the actions associated with the recorded content step 38, as shown in FIG. 2. In the latter case, the user selects one of the update options via step 82, in FIG. 5. If the user selects step 84, the audio piece is re-recorded and the new recording replaces the existing one. If the user selects step 86, a new audio piece is recorded and appended to the existing one. Finally, if the user selects step 88, the user is given the ability to update or delete existing portions of the content, or insert new content.

An important feature of the current invention is the fact that a workflow process is capable of triggering the content editing and update process described above. This occurs when, for example, an organization utilizes the services provided by platform 10, as shown in FIG. 1, and requires that the instant system conforms with such organization's workflow processes.

FIG. 6 shows a specific example of the steps involved in an application-specific authoring interaction of the user of platform 10 with platform 10, in this instance, dedicated to a conference call. In this example, a user of platform 10 taps into an ongoing conference call 90, which is monitored by platform 10. While the conference call is ongoing, the user is given the option to create a content piece to be inserted into the conference call in step 92, via platform 10, which is created at step 96. The content piece may be in audio or textual format. In the former case, the recorded content capabilities described in FIG. 3 are employed. In the latter case, a text-to-speech synthesizer is employed to convert the text into audio. Alternatively, the user is provided the ability to select an existing content piece to be inserted into the conference call using a keyword search or content navigation.

Platform 10 schedules the content insertion in step 98 and inserts the piece into the conference call via step 100. For example, insertion can be pre-determined to occur during silent periods, or during a break specifically designed to permit such insertions to be aired.

In step 92, if the user elects not to insert content into the ongoing conference call, the user is given the option via step 94 of determining whether to end the user's involvement in the call and return via point 10 to platform 10. Otherwise, the user is returned via point 4000 to the listening step 90.

It should be understood by one of ordinary skill in the art that the inventors construe the word “server” to mean a separate, designated hardware solution, or a software solution where multiple such “server” run on the same computer or multiple hardware devices or computers.

While there have been shown, described and pointed out fundamental novel features of the invention as applied to preferred embodiments thereof, it will be understood that various omissions and substitutions and changes in the form and details of the device illustrated and in its operation may be made by those skilled in the art without departing from the spirit of the invention. It is the intention, therefore, to be limited only as indicated by the scope of the claims appended hereto.

We claim:

1. A system for authoring digitized information pieces, comprising:
(a) a telephone device for access to a global telecommunications system, and for providing commands and for retrieval and authoring of Internet-based content;
(b) an Internet-based platform for transmission of information to and from said telephone device via the global telecommunications systems and for receiving said commands and for managing authored digitized information pieces; and
(c) said platform comprising the following components:
(1) at least one telephony server for interfacing with said telephone device via the global telecommunications system;
(2) at least one server for providing instructions to the telephony server;
(3) at least one web server for receiving and transmitting content from the Internet;
(4) at least one media server for managing media information flow and storage;
(5) at least one storage device for receiving instructions from said media server and for storing and retrieving information in accordance with said instructions;
(6) at least one database server for managing metainformation data flow among the platform-accessed components;
(7) at least one general application server for hosting software necessary for the implementation of additional functionality; and
(8) software for providing authoring functions integrated to the components of the platform.

2. The system of claim 1, wherein said commands are recognized by recognition means selected from the group consisting of speech recognition, DTMF tone detection, WAP recognition, Web-based protocol recognition, and combinations thereof.

3. The system of claim 1, wherein said additional functionality is selected from the group comprising: authoring, media-encoding, accessing external content providers, multicasting, broadcasting, conference-calling and streaming.

4. The system of claim 1, wherein said additional functionality is authoring said content.

5. The system of claim 4, wherein said authoring functionality is selected from the group consisting of recorded content, real-time broadcast, content edit and update and application-specific authoring.

6. The system of claim 4, wherein said authoring functionality comprises the steps of:
(a) recording an audio piece;
(b) attaching keywords to the recorded audio piece;
(c) attaching an additional piece to the recorded audio piece;
(d) editing a recorded audio piece;
(e) reviewing work including the recorded audio piece;
(f) saving work; and
(g) committing work.

7. The system of claim 5, wherein said real-time broadcasting functionality comprises the steps of:
(a) starting a broadcast;
(b) determining whether a user is a broadcaster;
(c) where the user is a broadcaster:
(1) recording said broadcast as at least one digitized information piece;
(2) providing segmentation, editing and insertion functionality to the broadcaster in connection with the at least one digitized information piece; and
(d) where the user is not a broadcaster:
(1) providing audio listening functionality to the user.

8. The system of claim 7, wherein the user is not a broadcaster, and the user is further provided with recording and editing functionality over at least one piece of the at least one digitized information piece.

9. The system of claim 5, wherein said content edit and update functionality comprises the steps of:
(a) selecting a piece from the digitized information pieces;
(b) determining whether to edit, and where said determination is to edit, providing editing functionality of the selected piece; and
(c) determining whether to update, and where said determination is to update, providing the options of re-recording, appending and modifying the selected piece.

10. The system of claim 5, wherein said application is application-specific authoring.

11. The system of claim 10, wherein said application-specific authoring is applied to the digitized information pieces by way of a conference call, and further comprising the steps of:
(a) accessing the conference call via the platform and providing listening capabilities to users;
(b) determining whether insertion of content to the conference call is permitted;
(c) where insertion is permitted, then:
(1) creating an audio content piece;
(2) scheduling the timing for insertion of the created audio content piece;
(3) inserting the created audio content piece into the conference call at the time scheduled, and
(4) returning to step (a);
(d) where insertion is not permitted, then providing the options of terminating step (a) and continuing step (a).

12. A method for authoring via a telecommunication network having at least one telephone device and audio content to be published, comprising the steps of:
(a) interacting in command format with a user via the at least one telephone device;
(b) performing the following steps at least once in response to the command format:
(1) recording an audio piece;
(2) attaching keywords to the recorded audio piece;
(3) attaching an additional piece to the recorded audio piece;
(4) editing a recorded audio piece;
(5) reviewing as work the recorded audio pieces and attachments;
(6) saving the work; and
(7) committing the work.
